(19) United States
(12) Patent Application Publication
(10) Pub. No.: US 2025/0370666 A1
(43) Pub. Date: Dec. 4, 2025

(54) FIXING DEVICE

(71) Applicant: BROTHER KOGYO KABUSHIKI KAISHA, Nagoya (JP)

(72) Inventors: Mingguang Zhang, Nagoya (JP); Hirotaka Imaeda, Nagoya (JP)

(73) Assignee: BROTHER KOGYO KABUSHIKI KAISHA, Nagoya (JP)

(21) Appl. No.: 19/219,124

(22) Filed: May 27, 2025

(30) Foreign Application Priority Data
May 30, 2024 (JP) 2024-087679
May 30, 2024 (JP) 2024-087680

(51) Int. Cl. G06F 3/12; G06Q 10/083

(52) U.S. Cl. CPC G06F 3/121; G06F 3/1207; G06F 3/1219; G06F 3/1259; G06Q 10/083; G06F 3/1288

(57) ABSTRACT

A fixing device includes a heating roller rotatable about a first axis extending in a rotation axis direction, a first side frame, a second side frame, a first connecting frame connecting the first side frame and the second side frame, and a first temperature sensor. The first temperature sensor detects a temperature of the heating roller and includes a fixed portion that is fixed to the first connecting frame and a detecting portion. The first connecting frame includes a first wall portion extending in the rotation axis direction, a second wall portion extending from a side of the first wall portion at an angle with respect to the first wall portion, and a third wall portion extending from a side of the second wall portion opposite to the first wall portion at an angle with respect to the second wall portion.

### REFERENCE TO RELATED APPLICATIONS

This application claims priority from Japanese Patent Application Nos. 2024-087679 and 2024-087680 filed on May 30, 2024. The entire contents of the priority applications are incorporated herein by reference.

### BACKGROUND ART

A fixing device used in an image forming apparatus is known in the art. The fixing device includes a heating roller that heats a sheet, and a temperature sensor that detects the temperature of the heating roller. The temperature sensor is a non-contact type temperature sensor spaced apart from a surface of the heating roller, and is fixed to a metal frame of the fixing device via a plastic holder having reinforcing ribs.

### SUMMARY

When non-contact type temperature sensors are used, detection errors occur according to the change in distance between the surface of the heating roller and the temperature sensor. For example, if the temperature sensor is fixed to the metal frame without a holder, the metal frame is susceptible to deformation since it is not reinforced by the holder having reinforcing ribs. If the metal frame is susceptible to deformation, due to changes of the distance between the temperature sensor and the surface of the heating roller, detection errors may become larger.

It would be desirable to restrain change in the distance between the surface of the heating roller and the temperature sensor to make detection errors of the temperature sensor smaller.

In one aspect, the fixing device comprises a heating roller, a first side frame, a second side frame, a first connecting frame, and a first temperature sensor.

The heating roller is rotatable about a first axis extending in a rotation axis direction. The first side frame supports one end portion of the heating roller in the rotation axis direction. The heating roller is rotatable in a state where the first side frame supports the one end portion of the heating roller. The second side frame supports the other end portion of the heating roller in the rotation axis direction. The heating roller is rotatable in a state where the second side frame supports the other end portion of the heating roller. The first connecting frame connects the first side frame and the second side frame. The first connecting frame is made of metal. The first temperature sensor detects the temperature of the heating roller. The first temperature sensor includes a fixed portion that is fixed to the first connecting frame and a detecting portion facing a surface of the heating roller. The detecting portion and the surface of the heating roller are separated by an air gap.

The first connecting frame comprises a first wall portion, a second wall portion, and a third wall portion. The first wall portion extends in the rotation axis direction. The second wall portion extends from a side of the first wall portion. The second wall portion extends at an angle with respect to the first wall portion. The third wall portion extends from a side of the second wall portion opposite to the first wall portion. The third wall portion extends at an angle with respect to the second wall portion.

Since the first connecting frame includes a first wall portion, a second wall portion extending from the first wall portion at an angle with respect to the first wall portion, and a third wall portion extending from the second wall portion at an angle with respect to the second wall portion, rigidity of the second wall portion can be increased and deformation of the second wall portion can be restrained.

The first temperature sensor may be fixed to the second wall portion.

Since change in distance between the surface of the heating roller and the first temperature sensor fixed to the second wall portion is restrained, detection errors of the first temperature sensor are reduced.

The third wall portion may extend from the second wall portion in a direction away from the heating roller. The first temperature sensor may be fixed to a first surface of the second wall portion opposite to a side on which the heating roller is located. The third wall portion may comprise a first opening through which the first temperature sensor passes.

Since the third wall portion extends from the second wall portion at an angle in a direction away from the heating roller, the first temperature sensor is fixed to the first surface opposite to the side on which the heating roller is located, and the third wall portion comprises a first opening through which the first temperature sensor passes. Thus, the heat from the heating roller can be restrained by the third wall portion from being transferred to the fixed portion of the first temperature sensor. As a result, the heat from the heating roller can be restrained from adversary affecting the fixed portion of the first temperature sensor.

A dimension of the first wall portion in the rotation axis direction may be greater than a dimension of the first opening of the third wall portion in the rotation axis direction.

Since the dimension of the first wall portion is larger than the dimension of the first opening of the third wall portion in the rotation axis direction, the decrease in rigidity of the first connecting frame due to the first opening can be compensated by the first wall portion.

The first temperature sensor may be fixed to the second wall portion by a screw, with a spring located between the fixed portion and the second wall portion.

Since the first temperature sensor is fixed to the second wall portion by the screw with the spring located between the fixed portion and the second wall portion, the distance between the heating roller and the first temperature sensor can be adjusted by turning the screw.

The second wall portion may include a first insertion portion on a longitudinal end thereof on one side in the rotation axis direction. The first insertion portion may protrude toward the one side in the rotation axis direction. The first side frame may have a first hole that receives the first insertion portion to locate the first insertion portion in place.

Since the second wall portion includes the first insertion portion and the first side frame has the first hole, the second wall portion can be located accurately in place with respect to the first side frame. As a result, the accuracy of the positional relationship between the heating roller and the first temperature sensor can be increased.

The first connecting frame may include a first fastening wall portion that extends in a direction perpendicular to the rotation axis direction from a longitudinal end of the second wall portion on one side in the rotation axis direction. The first fastening wall portion may be fastened to the first side frame by a screw.

Since the first connecting frame includes the first fastening wall portion, the first connecting frame can be restrained from becoming detached from the first side frame. Since the first fastening wall portion extends at an angle from the longitudinal end of the second wall portion, the rigidity of the second wall portion is increased, and deformation of the second wall portion can be restrained.

The first connecting frame may further comprise a fourth wall portion extending from a side of the third wall portion opposite to the side on which the second wall portion is located. The fourth wall portion may extend at an angle with respect to the third wall portion.

Since the first connecting frame includes the fourth wall portion, the rigidity of the first connecting frame is increased, and deformation of the first connecting frame can be restrained.

The fixing device may further comprise a thermostat spaced apart from the heating roller, the thermostat shuts off power to the heating roller when a surface temperature of the heating roller exceeds a predetermined temperature. The fourth wall portion may have a second opening that exposes a temperature detecting surface of the thermostat toward the heating roller.

Since the fourth wall portion has the second opening, the thermostat and the fourth wall portion do not interfere with each other.

The fixing device may further comprise a second temperature sensor that contacts a surface of the heating roller and detects the temperature of the heating roller. The first connecting frame may further comprise an extending wall portion extending from the fourth wall portion at an angle with respect to the fourth wall portion. The second temperature sensor may be fixed to the extending wall portion.

Since the second temperature sensor is fixed to the extending wall portion extending at an angle from the fourth wall portion that has high rigidity, the accuracy of the position of the fixed portion of the second temperature sensor is increased, and the contact pressure of the second temperature sensor on the heating roller can be restrained from changing.

The fourth wall portion may include a second insertion portion on a longitudinal end thereof on one side in the rotation axis direction. The second insertion portion may protrude toward the one side in the rotation axis direction. The first side frame may have a second hole that receives the second insertion portion to locate the second insertion portion in place.

Since the fourth wall portion includes the second insertion portion and the first side frame has the second hole, the fourth wall portion can be located accurately in place with respect to the first side frame.

The fixing device may further comprise a second connecting frame made of metal that connects the first side frame and the second side frame. The rotation axis of the heating roller may be located between the first connecting frame and the second connecting frame as viewed in the rotation axis direction.

Since the rotation axis of the heating roller is located between the first connecting frame and the second connecting frame, rigidity of the fixing device is increased, and deformation of the fixing device can be restrained.

The fixing device may further comprise a shaft, a pressure member and an arm. The shaft may be located in a position different from a position of the first connecting frame and a position of the second connecting frame. The shaft may connect the first side frame and the second side frame. The pressure member may nip a sheet in combination with the heating roller. The arm may be rotatably supported by the shaft. The arm may push the pressure member toward heating roller. The shaft may be located in a position offset from the second connecting frame in a circumferential direction of the heating roller.

Since the shaft supporting the arm is located in a position offset from the position of the second connecting frame in the circumferential direction of the heating roller, rigidity of the fixing device is not decreased, and deformation of the entire fixing device can be restrained.

In addition, a fixing device used in an image forming apparatus including a first fixing member, a second fixing member, a side frame, an arm, a spring, and a cam is known in the art. The first fixing member nips a sheet in combination with the second fixing member. The arm is capable of pushing the second fixing member toward the first fixing member. The spring is a spring with one end engaging with the side frame and the other end engaging with the arm. The spring bias the arm such that the second fixing member is pushed toward the first fixing member. The nip pressure of the first fixing member and the second fixing member is changeable by moving the cam.

Since the spring biasing the arm is disposed on an end portion of the side frame, and a distance between the spring and the first fixing member is larger than a distance between the cam and the first fixing member, a part of the side frame with which the spring is engaged and the area around it is prone to deformation.

It would be desirable to restrain deformation of the side frame of the fixing device.

In one aspect, the fixing device may further comprise a pressure member, an arm, a spring, and a cam.

The pressure member nips a sheet in combination with the heating roller. The arm is rotatable about a second axis extending in the rotation axis direction. The arm pushes the pressure member toward the heating roller. The spring have one end engaged with the first side frame and the other end engaged with the arm. The spring biases the arm such that the pressure member is pushed toward the heating roller. The cam rotates about a third axis extending in the rotation axis direction. The cam moves the arm to change a nip pressure between the heating roller and the pressure member.

The spring may be located between the third axis and the first connecting frame as viewed in the rotation axis direction.

The first connecting frame may be located between the heating roller and a portion where the spring is engaged with the first side frame as viewed in the rotation axis direction.

Since the spring biasing the arm is located between the third axis and the first connecting frame and the first connecting frame is located between the spring and the heating roller, the distance between the spring and the heating roller is smaller than the distance between the cam and the heating roller, and the first spring engaging portion of the first side frame with which the spring is engaged is reinforced by the first connecting frame. As a result, the first side frame and the second side frame can be restrained from being deformed by the biasing force of the spring.

The spring may be located on the inner side of the fixing device, in the rotation axis direction, with respect to the first side frame.

Since the spring is located on the inner side of the fixing device, in the rotation axis direction, with respect to the first side frame, the first side frame and the second side frame can be restrained from deforming outwardly.

The first side frame and the first connecting frame may both be made of metal. The first connecting frame may include a first insertion portion on a longitudinal end thereof on one side in the rotation axis direction. The first insertion portion may protrude toward the one side in the rotation axis direction. The first side frame may have a first hole that receives the first insertion portion to locate the first insertion portion in place.

Since the first connecting frame includes the first insertion portion and the first side frame has the first hole, the second wall portion can be located accurately in place with respect to the first side frame.

The first side frame may comprise a base portion and a bearing portion that protrudes from the base portion. The bearing portion may support the cam in a rotatable manner. The bearing portion may have a shape of a hollow cylinder extending in the rotation axis direction.

Since the first bearing portion supporting the cam in a rotatable manner has a shape of a hollow cylinder extending in the first direction, a sliding area in which the cam rotates can be secured. As a result, the cam 7 can rotate smoothly and can be restrained from becoming detached.

The base portion may comprise a first reinforcing portion that protrudes in the rotation axis direction from an edge of a periphery of the base portion, the first reinforcing portion provided at an edge of an outer periphery of the base portion surrounding the bearing portion.

Since the base portion includes a first reinforcing portion, the portions around the first bearing portion can be restrained from deforming.

The first side frame may comprise a first support hole and a second reinforcing portion. The first support hole may support one end portion of the heating roller in a rotatable manner. The second reinforcing portion may be located between the first support hole and the bearing portion. The second reinforcing portion may protrude in the rotation axis direction.

Since the first side frame includes the second reinforcing portion, the portions around the first bearing portion can be restrained from deforming.

### BRIEF DESCRIPTION OF DRAWINGS

FIG. 1 is a cross-sectional view of a fixing device assuming a first nip pressure.

FIG. 2 is a cross-sectional view of the fixing device assuming a second nip pressure.

FIG. 3 is an illustration showing an electric connection of the fixing device and an image forming apparatus.

FIG. 4 is a perspective view of a fixing frame with a first temperature sensor, a second temperature sensor, and a thermostat removed.

FIG. 5 is a perspective view of the fixing frame with the first temperature sensor, the second temperature sensor, and the thermostat attached.

FIG. 6 is a perspective view of the fixing frame with a first side frame and a second side frame detached from a first connecting frame.

FIG. 7 is a perspective view of the fixing frame as viewed from an angle different from FIG. 4.

FIG. 8A is an illustration of the first connecting frame as viewed from a second direction.

FIG. 8B is a sectional view taken along line A-A of FIG. 8A.

FIG. 9 is an illustration of the fixing frame as viewed from a third direction.

FIG. 10 is a perspective view of the first side frame according to another embodiment.

### DESCRIPTION

An embodiment of the present disclosure will be described in detail referring to the drawings where appropriate.

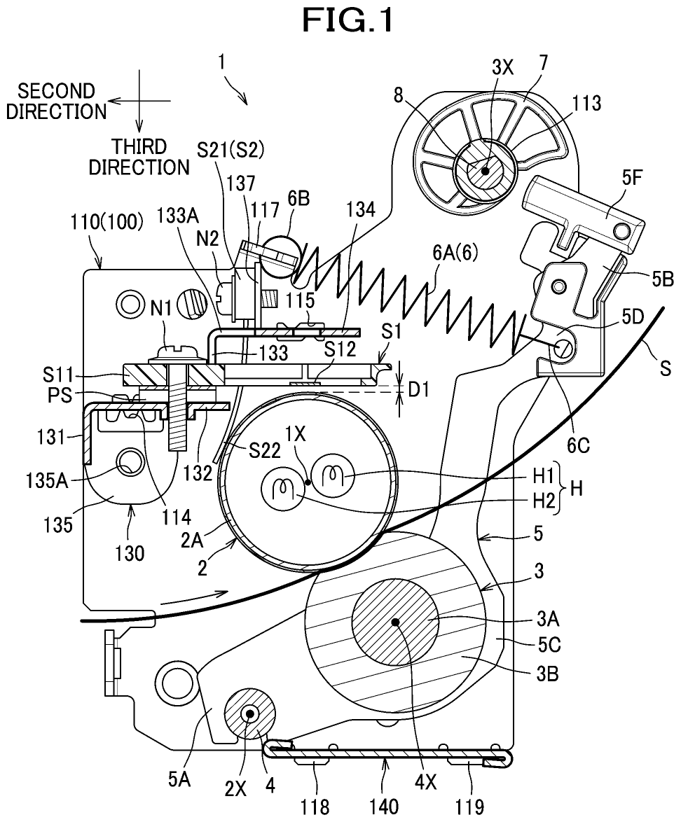

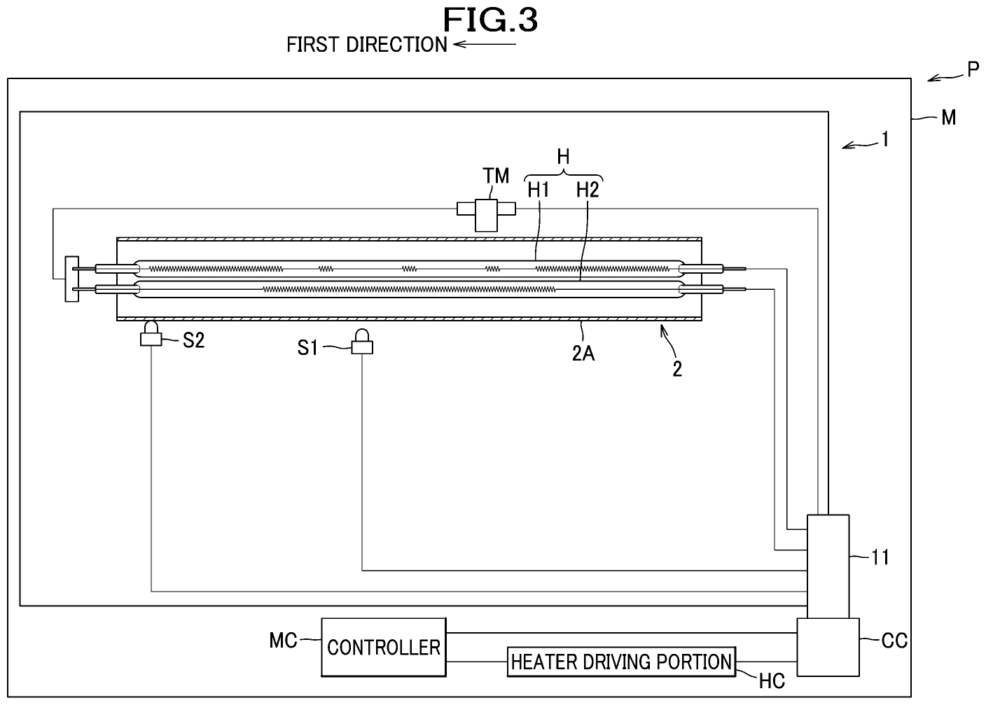

As shown in FIG. 1, a fixing device 1 is a device for fixing a toner image onto a sheet S. The fixing device 1 is installable in a main housing M (see FIG. 3) of an image forming apparatus P such as a printer.

The fixing device 1 comprises a heating roller 2, a pressure member 3, an arm shaft 4 as an example of a shaft, an arm 5, a spring 6, a cam 7, a cam shaft 8, and a fixing frame 10. The arm shaft 4, the arm 5, the spring 6, the cam 7, and the cam shaft 8 form a pressure changing mechanism for changing a nip pressure between the heating roller 2 and the pressure member 3. The arm 5, the spring 6, and the cam 7 are disposed on one side of the pressure changing mechanism in a first direction and on the other side of the pressure changing mechanism in the first direction. The structure of the pressure changing mechanism on the one side and the other side of the pressure changing mechanism are symmetrical. Therefore, the structure of the pressure changing mechanism on the one side of the pressure changing mechanism will be described and the description of the structure of the pressure changing mechanism on the other side will be omitted.

The heating roller 2, rotates about a first axis 1X as an example of a rotation axis. The heating roller 2 extends in a direction along the first axis 1X. The heating roller 2 comprises a roller 2A and a heater H. The roller 2A rotates about the first axis 1X extending in the rotation axis direction. In the present embodiment, the heating roller 2 comprises two heaters H1, H2. The roller 2A is heated by the heaters H1, H2. The heaters H1, H2 are located inside the roller 2A. The heaters H1, H2 are, for example, halogen heaters.

In the following description, the direction in which the first axis 1X of the heating roller 2 extends is simply referred to as “first direction”. A direction perpendicular to the first direction is simply referred to as “second direction”. A direction perpendicular to the first direction and the second direction is simply referred to as “third direction”. In the present embodiment, the first direction is the left-right direction, the second direction is a direction along the front-rear direction, and the third direction is the up-down direction. In the drawings, the arrows indicating the directions point toward one side in the respective directions, and the side opposite to the one side is the other side in the respective directions.

The pressure member 3 is a member that nips a sheet S in combination with the heating roller 2. In the present embodiment, the pressure member 3 is a roller that rotates about a fourth axis 4X. The pressure member 3 extends in the first direction. The pressure member 3 is driven by the heating roller 2 and rotates therewith. The pressure member 3 nips the sheet S in combination with the heating roller 2. The pressure member 3 comprises a roller shaft 3A and a roller body 3B. The roller shaft 3A is, for example, made of metal. The roller body 3B is, for example, made of rubber and covers an outer periphery of the roller shaft 3A.

The arm shaft 4 is made of metal and extends in the first direction.

The arm 5 is rotatably supported by the arm shaft 4. The arm 5 is capable of pushing the pressure member 3 toward the heating roller 2. The arm 5 has shape of an elongated plate and extends obliquely with respect to the second direction and third direction. The arm 5 has a first end portion 5A, a second end portion 5B, a first portion 5C, and a second portion 5D.

The first end portion 5A is an end portion of the arm 5 on one side in the second direction and on one side in the third direction. The first end portion 5A includes a groove engaged with the arm shaft 4, and is rotatably supported by the arm shaft 4. As a result, the arm 5 is rotatable about a second axis 2X.

The second end portion 5B is an end portion of the arm 5 opposite to the first end portion 5A. The second end portion 5B comprises a cam follower 5F. The cam follower 5F is contactable with the cam 7.

The first portion 5C and the second portion 5D are located between the first end portion 5A and the second end portion 5B. The first portion 5C supports the pressure roller 3. The second portion 5D is a portion to which the spring 6 is connected and has a hole with which one end of the spring 6 is engaged.

The spring 6 is a coil spring. The spring 6 has a coil portion 6A, a first end 6B, and a second end 6C. The first end 6B of the spring 6 is engaged with the fixing frame 100. The second end 6C of the spring 6 is engaged with the arm 5. The spring 6 biases the arm 5 such that the pressure member 3 is pushed toward the heating roller 2.

The cam shaft 8 is made of metal and extends in the first direction. The cam shaft 8 is rotatable about a third axis 3X.

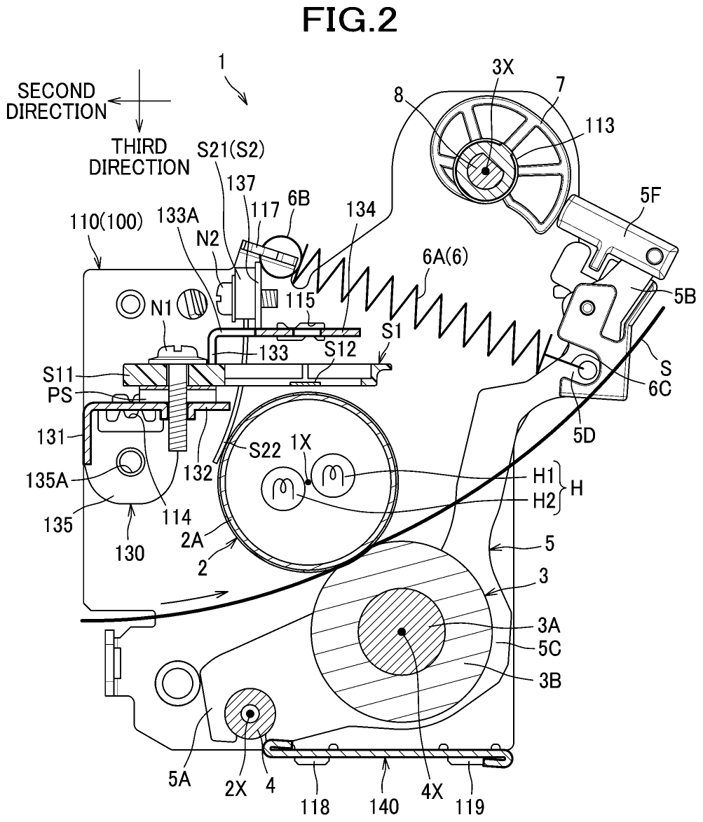

The cam 7 is fixed to the cam shaft 8 and is rotatable about the third axis 3X by the rotation of the cam shaft 8. More specifically, the cam 7 is rotatable between a first phase shown in FIG. 1 and a second phase shown in FIG. 2.

The first phase is a phase in which the nip pressure assumes a first nip pressure. The second phase is a phase in which the nip pressure assumes a second nip pressure which is lower than the first nip pressure. More specifically, as shown in FIG. 1, when the cam 7 is in the first phase, the cam 7 does not contact the cam follower 5F and the cam follower 5F is not pushed by the cam 7. As a result, the biasing force of the spring 6 is fully transmitted to the pressure member 3, and the nip pressure assumes a first nip pressure. On the other hand, when the cam 7 is in the second phase, the cam 7 contacts the cam follower 5F and the cam follower 5F is pushed by the cam 7. As a result, a part of the biasing force of the spring 6 is not transmitted to the pressure member 3, and the nip pressure assumes the second nip pressure which is lower than the first nip pressure. In this manner, the cam 7 rotates and is capable of changing the nip pressure of the heating roller 2 and the pressure member 3 by moving the arm 5.

As shown in FIG. 3, the image forming apparatus P in which the fixing device is installable comprises a controller MC, a heater driving portion HC, and a housing connector CC.

The controller MC, for example, comprises a central processing unit (CPU), a random-access memory (RAM), a read-only memory (ROM), and an input/output circuit, and performs various arithmetic processing based on programs and/or data stored in the ROM to execute control over the fixing device 1.

The heater driving portion HC is controlled by the controller MC and provides power to the heaters H1, H2 based on temperature information detected by a first temperature sensor S1 and a second temperature sensor S2.

The housing connector CC is a connector to which a fixing connector 11 of the fixing device is connected in a state where the fixing device 1 is installed in the main housing M.

The fixing device 1 further comprises a first temperature sensor S1, a second temperature sensor S2, a thermostat TM, and a fixing connector 11.

The first temperature sensor S1 detects a temperature of the heating roller 2. The first temperature sensor S1 is a non-contact type sensor spaced apart from the heating roller 2. The first temperature sensor S1 is located at a central portion of the heating roller 2 in the first direction. The first temperature sensor S1 is located within an area of the heating roller 2 through which the sheet S is conveyed.

As shown in FIG. 1, the first temperature sensor S1 includes a fixed portion S11 and a detecting portion S12. The fixed portion S11 is a portion fixed to the fixing frame 100. More specifically, the fixed portion S11 is fixed to a first connecting frame 130 which will be described below. The detecting portion S12 is a thermistor whose resistance changes according to the temperature. The detecting portion S12 faces a surface of the heating roller 2. The detecting portion S12 and the surface of the heating roller 2 is separated by an air gap. In the present embodiment, a distance D1 of the air gap is 0.5 mm to 2.0 mm.

The second temperature sensor S2 detects a temperature of the heating roller 2. The second temperature sensor S2 is a contact-type sensor which is in contact with the surface of the heating roller 2. The second temperature sensor S2 is located at an end portion of the heating roller 2 in the first direction. The second temperature sensor S2 is located outward of the area of the heating roller 2 through which the sheet S is conveyed. The second temperature sensor S2 includes a fixed portion S21 and a detecting portion S22. The fixed portion S21 is a part fixed to the fixing frame 100. The detecting portion S22 is a thermistor whose resistance changes according to the temperature. The detecting portion S22 is in contact with the surface of the heating roller 2.

The controller MC controls the heaters H1, H2 which heat the heating roller 2 based on the temperatures detected by the first temperature sensor S1 and the second temperature sensor S2.

The thermostat TM is an element that shuts off power to the heating roller 2 when a surface temperature of the heating roller 2 exceeds a predetermined temperature. The thermostat TM is spaced apart from the heating roller 2. The thermostat TM is located at a central portion of the heating roller 2 in the first direction. The thermostat TM is located within an area of the heating roller 2 through which the sheet S is conveyed.

The fixing connector 11 is a connector that is connected to the housing connector CC when the fixing device 1 is installed in the main housing M. When the fixing connector 11 and the housing connector CC are connected, the controller MC can receive the information detected by the first temperature sensor S1 and the second temperature sensor S2, and control the heaters H1, H2 by providing power to the heaters H1, H2 from the heater driving portion HC.

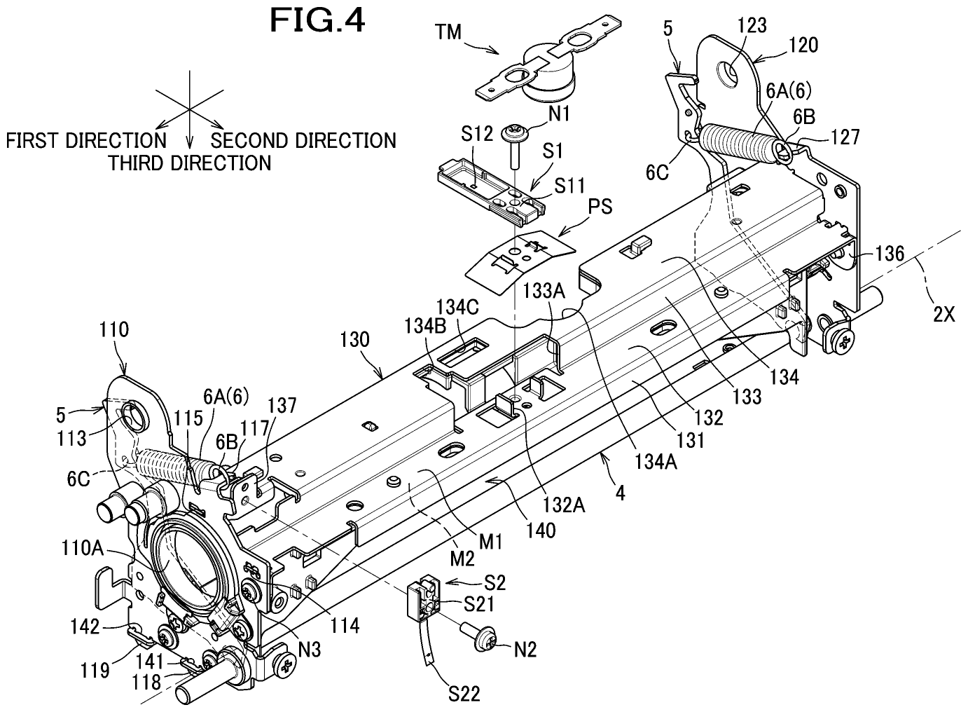

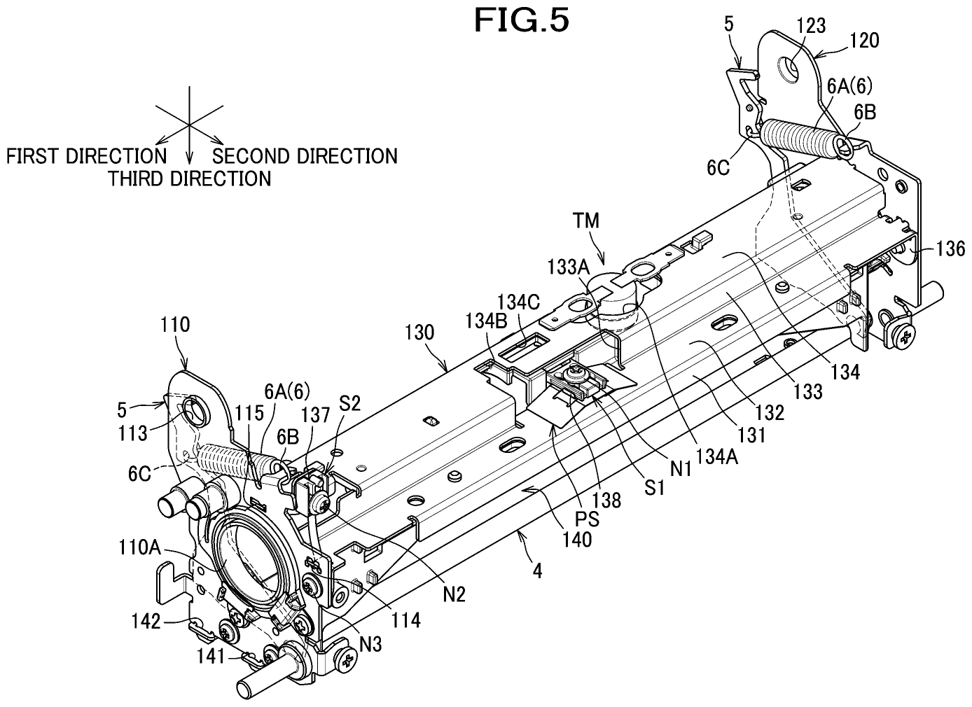

As show in FIGS. 4 and 5, the fixing frame 100 comprises a first side frame 110, a second side frame 120, a first connecting frame 130, and a second connecting frame 140. The first side frame 110, the second side frame 120, the first connecting frame 130, and the second connecting frame 140 are made of sheet metal. In the present embodiment, the sheet metal is made of steel.

In the present embodiment, the arm 5, the spring 6, and the cam 7 are located between the first side frame 110 and the second side frame 120 (also refer to FIG. 1). In other words, the arm 5, the spring 6, and the cam 7 are located inward of the first side frame 110 and the second side frame 120 in the first direction.

The first side frame 110 is located on the one side in the first direction. The first side frame 110 supports an end portion of the heating roller 2 on the one side in the first direction in a manner that allows the heating roller 2 to rotate.

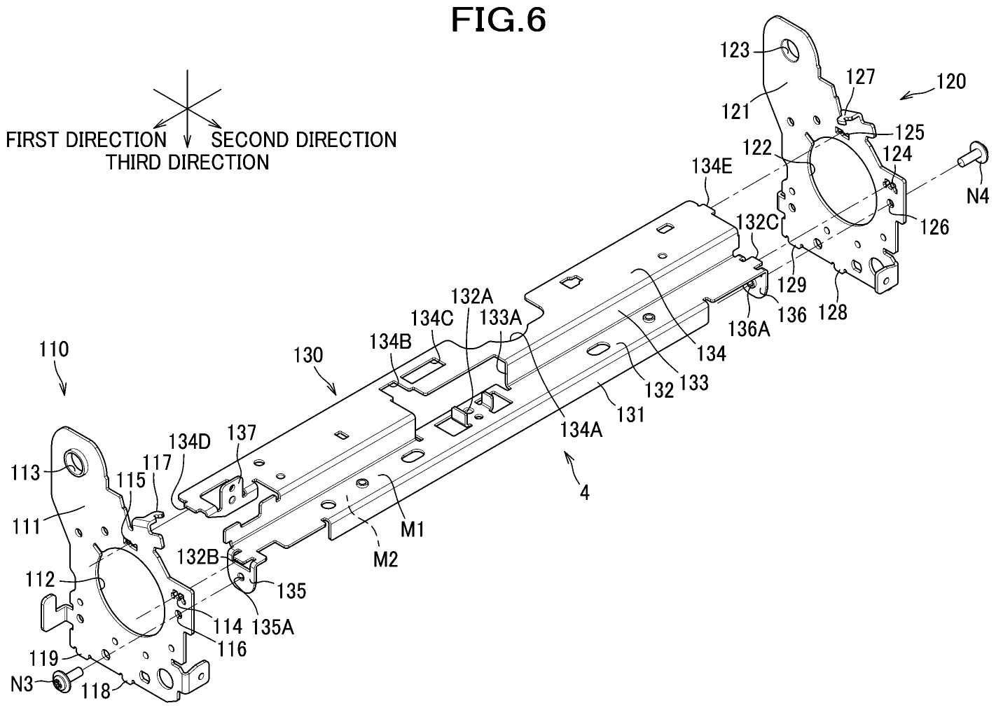

As shown in FIG. 6, the first side frame 110 includes a first base portion 111, a first support hole 112, a first bearing portion 113 as an example of a bearing portion, a first hole 114, a second hole 115, a third hole 116, a first spring engaging portion 117, a first protrusion 118, a second protrusion 119, and a bearing 110A.

The first support hole 112 is a circular hole formed in a central portion of the first base portion 111. The bearing 110A is attached to the first support hole 112. The bearing 110A supports the end portion of the heating roller 2 on the one side in the first direction in a manner that allows the heating roller 2 to rotate.

The first bearing portion 113 protrudes from the first base portion 111 toward the one side in the first direction. The first bearing portion 113 has a shape of a hollow cylinder extending in the first direction. The first bearing portion 113 supports the cam shaft 8 in a manner that allows the cam shaft 8 to rotate (also refer to FIG. 1). As a result, the first bearing portion 113 supports the cam 7 via the cam shaft 8 in a manner that allows the cam 7 to rotate.

The first hole 114 is a hole formed in the first base portion 111 (also refer to FIG. 1). The first hole 114 is an elongated hole having a shape of the letter M long in the second direction. A part of the first connecting frame 130 is inserted in the first hole 114. More specifically, the first hole 114 locates a first insertion portion 132B of the first connecting frame 130 which will be described later in place when the first insertion portion 132B of the first connecting frame 130 is inserted in the first hole 114.

The second hole 115 is a hole formed in the first base portion 111 (also refer to FIG. 1). The second hole 115 is a hole elongate in the second direction. A part of the first connecting frame 130 is inserted in the second hole 115. More specifically, the second hole 115 locates a second insertion portion 134D of the connecting frame 130 in place when the second insertion portion 134D of the first connecting frame 130 is inserted in the second hole 115.

The third hole 116 is a hole formed in the first base portion 111. The third hole 116 is located at an end portion of the first base portion 111 on one side in the second direction. The third hole 116 is a hole through which a screw N3 that fastens a first fastening wall portion 135 and the first side frame 110 passes.

The first spring engaging portion 117 is formed on an end portion of the first base portion 111 on the other side in the third direction. The first spring engaging portion 117 extends from the first base portion 111 toward the other side in the first direction. The first spring engaging portion 117 has a groove on its end. The first end 6B of the spring 6 is engaged with the groove.

The first protrusion 118 and the second protrusion 119 each protrude toward the one side in the third direction from an end of the first base portion 111 on the one side in the third direction. The first protrusion 118 and the second protrusion 119 are located side by side in the second direction. The first protrusion 118 is located on the one side in the second direction of the second protrusion 119.

The second side frame 120 is located at the other side in the first direction. The second side frame 120 is formed in a shape symmetrical to the first side frame 110. The second side frame 120 supports an end portion of the heating roller 2 on the other side in the first direction in a manner that allows the heating roller 2 to rotate.

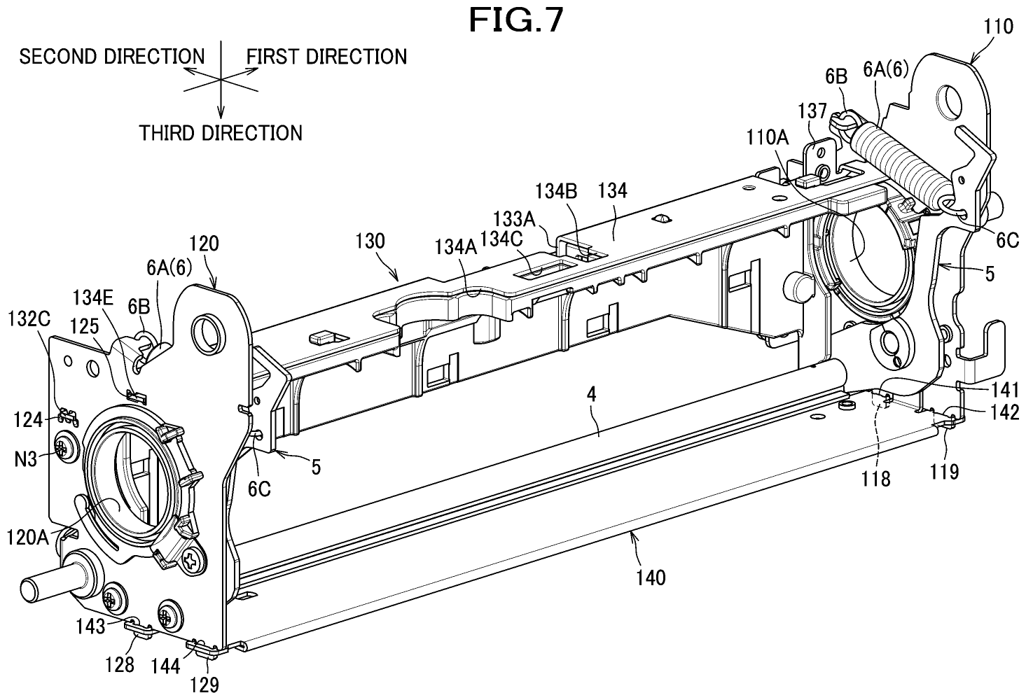

As shown in FIGS. 6 and 7, the second side frame 120 includes a second base portion 121, a second support hole 122, a second bearing portion 123 as an example of a bearing portion, a fourth hole 124, a fifth hole 125, a sixth hole 126, a second spring engaging portion 127, a third protrusion 128, a fourth protrusion 129, and a bearing 120A.

The second support hole 122 is a hole formed in a central portion of the second base portion 121. The bearing 120A is attached to the second support hole 122. The bearing 120A supports the end portion of the heating roller 2 on the other side in the first direction in a manner that allows the heating roller to rotate.

The second bearing portion 123 extends from the second base portion 121 toward the other side in the first direction. The second bearing portion 123 has a shape of a hollow cylinder extending in the first direction. The second bearing portion 123 supports the cam shaft 8 in a manner that allows the cam shaft 8 to rotate (also refer to FIG. 1). As a result, the second bearing portion 123 supports the cam 7 via the cam shaft 8 in a manner that allows the cam 7 to rotate.

The fourth hole 124 is a hole formed in the second base portion 121. The fourth hole 124 is an elongated hole having a shape of the letter M long in the second direction. A part of the first connecting frame 130 is inserted in the fourth hole 124. More specifically, the fourth hole 124 locates a third insertion portion 132C of the first connecting frame 130 which will be described below in place when the third insertion portion 132C of the first connecting frame 130 is inserted in the fourth hole 124.

The fifth hole 125 is a hole formed in the second base portion 121. The fifth hole 125 is a hole elongate in the second direction. A part of the first connecting frame 130 is inserted in the fifth hole 125. More specifically, the fifth hole 125 locates a fourth insertion portion 134E of the first connecting frame 130 which will be described below in place when the fourth insertion portion 134E of the first connecting frame 130 is inserted in the fifth hole 125.

The sixth hole 126 is a hole formed in the second base portion 121. The sixth hole 126 is located at an end portion of the second base portion 121 on the one side in the second direction. The sixth hole 126 is a hole through which a screw N4 that fastens a second fastening wall portion 136 and the second side frame 120 passes.

The second spring engaging portion 127 is formed on an end portion of the second base portion 121 on the other side in the third direction. The second spring engaging portion 127 extends from the end portion of the second base portion 121 toward the one side in the first direction. The second spring engaging portion 127 has a groove on its end. The first end 6B of the spring 6 is engaged with the groove.

The third protrusion 128 and the fourth protrusion 129 each protrude from an end of the second base portion 121 on the one side in the third direction toward the one side in the third direction. The third protrusion 128 and the fourth protrusion 129 are located side by side in the second direction. The third protrusion 128 is located on the one side in the second direction of the fourth protrusion 129.

The first connecting frame 130 is a frame that connects the first side frame 110 and the second side frame 120. The first connecting frame 130 extends in the first direction. The first connecting frame 130 comprises a first wall portion 131, a second wall portion 132, a third wall portion 133, a fourth wall portion 134, a first fastening wall portion 135, a second fastening wall portion 136, and an extending wall portion 137.

The first wall portion 131 is a wall extending in the first direction and the third direction. The first wall portion 131 does not contact the first side frame 110 or the second side frame 120.

The second wall portion 132 extends from a side of the first wall portion 131 on the other side in the third direction at an angle with respect to the first wall portion 131. In the present embodiment, the second wall portion 132 extends from the side of the first wall portion 131 on the other side in the third direction toward the other side in the second direction. The second wall portion 132 is perpendicular to the first wall portion and extends in the first direction and the second direction. The second wall portion 132 includes a first sensor fixing portion 132A, a first insertion portion 132B, and a third insertion portion 132C.

The first sensor fixing portion 132A is located at a central portion of the second wall portion 132 in the first direction. As shown in FIGS. 4 and 5, the first sensor fixing portion 132A has a screw hole to which the first temperature sensor S1 is fixed. The first sensor S1 is fixed to the first sensor fixing portion 132A by a screw N1. In the present embodiment, the first temperature sensor S1 is fixed to the second wall portion 32 by the screw N1 with a leaf spring PS as an example of a spring located between the first temperature sensor S1 and the second wall portion 132. In this way, the first temperature sensor S1 is fixed to the second wall portion 132.

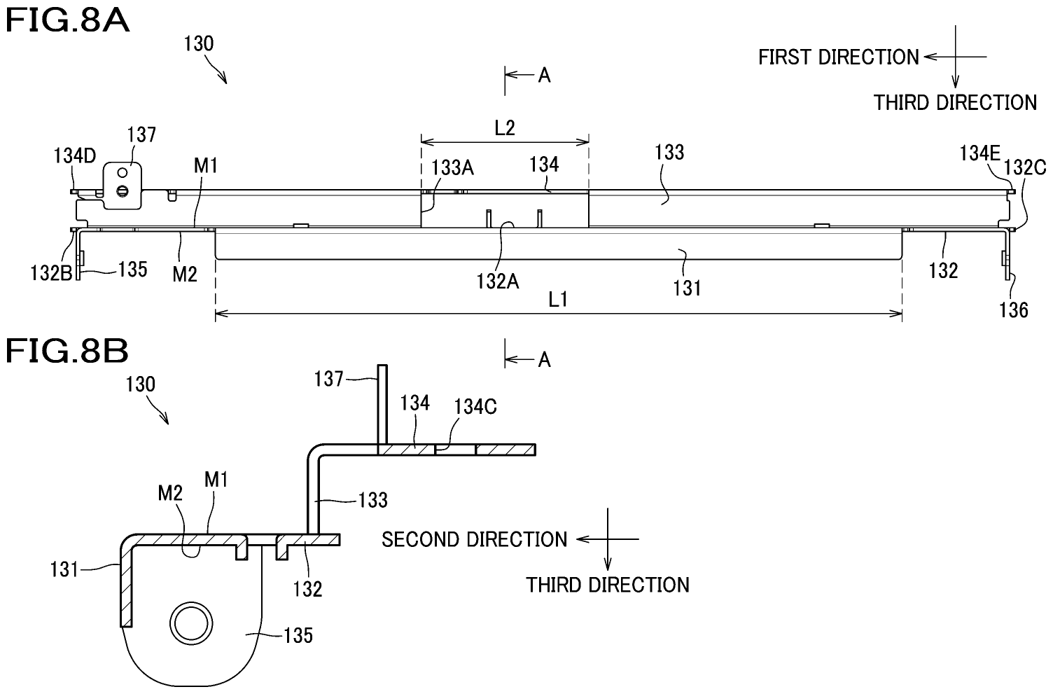

As shown in FIG. 8A, the second wall portion 132 has a first surface M1 and a second surface M2. The first surface M1 is a surface of the second wall portion 132 on a side opposite to a side on which the heating roller 2 is located. The second surface M2 is a surface of the second wall portion 132 opposite to the first surface M1. The first temperature sensor S1 is fixed to the first surface M1.

As shown in FIG. 6, the first insertion portion 132B is located on an end of the second wall portion 132 on the one side in the first direction. More specifically, the first insertion portion 132B is a protrusion that protrudes from the end of the second wall portion 132B on the one side in the first direction toward the one side in the first direction. The first side frame 110 locates the first connecting frame 130 in place when the first insertion portion 132B is inserted in the first hole 114 of the first side frame 110.

The third insertion portion 132C is located on an end of the second wall portion 132 on the other side in the first direction. More specifically, the third insertion portion 132C is a protrusion that protrudes from the end of the second wall portion 132B on the other side in the first direction toward the other side in the first direction. The second side frame 120 locates the first connecting frame 130 in place when the third insertion portion 132C is inserted in the fourth hole 124 of the second side frame 120.

The first fastening wall portion 135 extends from an end of the second wall portion 132 on the one side in the first direction at an angle with respect to the second wall portion 132. The first fastening wall portion 135 extends from the end of the second wall portion 132 on the one side in the first direction toward the one side in the third direction. The first fastening wall portion 135 has a screw hole 135A. The first fastening wall portion 135 is fastened to the first side frame 110 by a screw N3.

The second fastening wall portion 136 extends from an end of the second wall portion 132 on the other side in the first direction at an angle with respect to the second wall portion 132. The second fastening wall portion 136 extends from the end of the second wall portion 132 on the other side in the first direction toward the one side in the third direction. The second fastening wall portion 136 has a screw hole 136A. The second fastening wall portion 136 is fastened to the second side frame 120 by a screw N4.

The third wall portion 133 extends from a side of the second wall portion 132 opposite to the side on which the first wall portion 131 is located at an angle with respect to the second wall portion 132. More specifically, the third wall portion 133 extends from the second wall portion 132 in a direction away from the heating roller 2. In the present embodiment, the third wall portion 133 extends from a side of the second wall portion 132 on the other side in the second direction toward the other side in the third direction. The third wall portion 133 is perpendicular to the second wall portion 132 and extends in the first direction and the third direction. The third wall portion 133 has a first opening 133A.

The first opening 133A is an opening through which the first sensor S1 passes when the first sensor S1 is fixed to the first connecting frame 130. The first opening 133A is formed at a central portion of the third wall portion 133 in the first direction. As shown in FIG. 8A, a dimension L1 of the first wall portion 131 in the first direction is larger than a dimension L2 of the first opening 133A of the third wall portion 133 in the first direction.

As shown in FIG. 6, the fourth wall portion 134 extends from a side of the third wall portion 133 opposite to the side on which the second wall portion 132 is located at an angle with respect to the third wall portion 133. In the present embodiment, the fourth wall portion 134 extends from a side of the third wall portion 133 on the other side in the third direction toward the other side in the second direction. The fourth wall portion 134 is perpendicular to the third wall portion 133 and extends in the first direction and the second direction. The fourth wall portion 134 has a second opening 134A, a third opening 134B, a fourth opening 134C, a second insertion portion 134D, and a fourth insertion portion 134E.

The second opening 134A is an opening formed at a central portion of the fourth wall portion 134 in the first direction. The second opening 134A is a notch (refer to FIG. 5) formed such that the thermostat TM can pass therethrough. The second opening 134A exposes a temperature detecting surface of the thermostat TM toward the heating roller 2. In addition, the thermostat TM is fixed to the fixing frame 100 while being held by a plastic holder not shown in the drawings.

The third opening 134B is an opening formed continuously from the first opening 133A of the third wall portion 133.

The fourth opening 134C is a rectangular hole formed at a central portion of the fourth wall portion 134 in the first direction. The fourth opening 134C is located at a position overlapping with the detecting portion S12 of the first temperature sensor S1 as viewed in the third direction. The fourth opening 134C is a hole through which a laser beam for detecting a position of the detecting portion S12 passes (also refer to FIG. 8B). The laser beam is used to adjust a distance D1 between the detecting portion S12 and the heating roller 2.

The second insertion portion 134D is located at an end of the fourth wall portion 134 on the one side in the first direction. More specifically, the second insertion portion 134D is a protrusion that protrudes from the end of the fourth wall portion 134 on the one side in the first direction toward the one side in the first direction. The first side frame 110 locates the first connecting frame 130 in place when the second insertion portion 134D is inserted in the second hole 115 of the first side frame 110.

The fourth insertion portion 134E is located at an end of the fourth wall portion 134 on the other side in the first direction. More specifically, the fourth insertion portion 134E is a protrusion that protrudes from the end of the fourth wall portion 134 on the other side in the first direction toward the other side in the first direction. The second side frame 120 locates the first connecting frame 130 in place when the fourth insertion portion 134E is inserted in the fifth hole 125 of the second side frame 120.

The extending wall portion 137 is located on an end portion of the fourth wall portion 134 on the one side in the first direction. The extending wall portion 137 extends from the fourth wall portion 134 at an angle with respect to the fourth wall portion 134. The extending wall portion 137 extends in a direction away from the heating roller 2. More specifically, the extending wall portion 137 extends from a side on the one side in the second direction of the end portion of the fourth wall portion 134 toward the other side in the third direction. The second temperature sensor S2 is fixed to the extending wall portion 137. In the present embodiment, the second temperature sensor S2 is fixed to the extending wall portion 137 by a screw N2 (refer to FIG. 5).

As shown in FIG. 7, the second connecting frame 140 is a frame connecting the first side frame 110 and the second side frame 120.

The second connecting frame 140 has a first connecting hole 141, a second connecting hole 142, a third connecting hole 143, and a fourth connecting hole 144.

The first connecting hole 141 and the second connecting hole 142 are located on an end portion of the second connecting frame 140 on the one side in the first direction. The first connecting hole 141 locates the first protrusion 118 of the first side frame 110 in place when the first protrusion 118 of the first side frame 110 is inserted in the first connecting hole 141. The second connecting hole 142 locates the second protrusion 119 of the first side frame 110 in place when the second protrusion 119 of the first side frame 110 is inserted in the second connecting hole 142.

The third connecting hole 143 and the fourth connecting hole 144 are located on an end portion of the second connecting frame 140 on the other side in the first direction. The third connecting hole 143 locates the third protrusion 128 of the second side frame 120 in place when the third protrusion 128 of the second side frame 120 is inserted in the third connecting hole 143. The fourth connecting hole 144 locates the fourth protrusion 129 of the second side frame 120 in place when the fourth protrusion 129 of the second side frame 120 is inserted in the fourth connecting hole 144.

The positional relationship of the arm shaft 4, the arm 5, the spring 6, the cam 7, the cam shaft 8, the first connecting frame 130, and the second connecting frame 140 will be described in detail with reference made to FIG. 1.

As shown in FIG. 1, the arm shaft 4, the cam shaft 8, the first connecting frame 130, and the second connecting frame 140 are each located in a position different from each other and connect the first side frame 110 and the second side frame 120 at different positions.

The spring 6 is located between the third axis 3X, which is the rotation axis of the cam shaft 8, and the first connecting frame 130, as viewed in the first direction.

The first connecting frame 130 is located between the first spring engaging portion 117, which is a portion of the first side frame 110 with which the spring 6 is engaged, and the heating roller 2, as viewed in the first direction.

The first axis 1X, which is the rotation axis of the heating roller 2, is located between the first connecting frame 130 and the second connecting frame 140 as viewed in the first direction.

The pressure member 3 is located between the heating roller 2 and the second connecting frame 140 as viewed in the first direction.

The arm shaft 4 is located in a position offset from a position of the second connecting frame 140 in a circumferential direction of the heating roller 2.

According to the above, the following advantageous effects may be obtained by the present embodiment.

Since the first temperature sensor S1 is a non-contact type temperature sensor, a change in the distance D1 between the surface of the heating roller 2 and the detection portion S12 causes detection errors according to the change in the distance D1 occurs.

However, in the fixing device 1 according to the present embodiment, the first connecting frame 130 to which the first temperature sensor S1 is fixed includes a first wall portion 131, a second wall portion 132 extending from the first wall portion 131 at an angle with respect to the first wall portion 131, and a third wall portion 133 extending from the second wall portion 132 at an angle with respect to the second wall portion 132. Since the first connecting frame 130 has a stepped shape, the rigidity of the second wall portion 132 is increased, and deformation of the second wall portion 132 can be restrained. As a result, the change in the distance D1 between the first temperature sensor S1 fixed to the second wall portion 132 and the heating roller 2 is restrained, and the detection error of the first temperature sensor S1 is reduced.

The third wall portion 133 extends from the second wall portion 132 at an angle with respect to the second wall portion 132 in a direction away from the heating roller 2. The first temperature sensor S1 is fixed to the first surface M1 opposite to the side on which the heating roller 2 is located, and the third wall portion 133 has a first opening 133A through which the first temperature sensor S1 passes. Thus, the heat from the heating roller 2 can be restrained by the third wall portion 133 from being transferred to the fixed portion S11 of the first temperature sensor S1. As a result, the heat from the heating roller 2 can be restrained from adversely affecting the fixed portion S11 of the first temperature sensor S1.

The dimension L1 of the first wall portion 131 is larger than the dimension L2 of the first opening 133A of the third wall portion 133 in the first direction. Thus, the decrease in rigidity of the first connecting frame 130 due to the first opening 133A can be compensated by the first wall portion 131.

The first temperature sensor S1 is fixed to the second wall portion 132 by the screw N1 with the leaf spring PS located between the first temperature sensor S1 and the second wall portion 132. Thus, the distance D1 between the heating roller 2 and the first temperature sensor S1 can be adjusted by turning the screw N1.

The second wall portion 132 of the first connecting frame 130 includes the first insertion portion 132B and the first side frame 110 has the first hole 114. Thus, the second wall portion 132 can be located accurately in place with respect to the first side frame 110. As a result, the accuracy of the positional relationship between the heating roller 2 and the first temperature sensor S1 can be increased. The first insertion portion 132B and the first hole 114 are used to locate the first connecting frame 130 and the first side frame 110 in place. Thus, there are no screws located between the heating roller 2 and the spring 6, and the fixing housing 100 can thereby be downsized.

The first connecting frame 130 includes the first fastening wall portion 135. Thus, the first connecting frame 130 can be restrained from becoming detached from the first side frame 110. The first connecting frame 130 includes the second fastening wall portion 136. Thus, the first connecting frame 130 can be restrained from becoming detached from the second side frame 120. The first fastening wall portion 135 and the second fastening wall portion 136 extend from the ends of the second wall portion 132 at an angle with respect to the second wall portion 132. Thus, the rigidity of the second wall portion 132 is increased, and deformation of the second wall portion 132 can be restrained.

The first connecting frame 130 includes the fourth wall portion 134. Thus, the rigidity of the first connecting frame 130 is further increased, and deformation of the first connecting frame 130 can be restrained.

The fourth wall portion 134 has the second opening 134A. Thus, the thermostat TM and the fourth wall portion 134 do not interfere with each other. As a result, the fixing device 1 will not be upsized even if the thermostat TM is provided.

The second temperature sensor S2 is fixed to the extending wall portion 137 extending at an angle from the fourth wall portion 134 that has high rigidity. Thus, the accuracy of the position of the fixed portion of the second temperature sensor S2 is increased, and the contact pressure of the second temperature sensor S2 on the heating roller 2 can be restrained from changing.

The fourth wall portion 134 includes the second insertion portion 134D and the first side frame 110 has the second hole 115. Thus, the fourth wall portion 132 can be located accurately in place with respect to the first side frame 110. As a result, the accuracy of the positional relationship between the heating roller 2 and the second temperature sensor S2 can be increased. The second insertion portion 134D and the second hole 115 are used to locate the first connecting frame 130 and the first side frame 130 in place. Thus, there are no screws located between the heating roller 2 and the spring 6, and the fixing housing 100 can thereby be downsized.

The first axis 1X, which is the rotation axis of the heating roller 2, is located between the first connecting frame 130 and the second connecting frame 140. Since the heating roller 2 is surrounded by the first side frame 110, the second side frame 120, the first connecting frame 130, and the second connecting frame 140, deformation of the fixing device 1 can be restrained even if the heating roller 2 repeatedly rotates and stops.

The arm shaft 4 supporting the arm 5 is located in a position offset from the position of the second connecting frame 140 in the circumferential direction of the heating roller 2. Thus, rigidity of the fixing device 1 is not decreased, and deformation of the entire fixing device 1 can thereby be restrained.

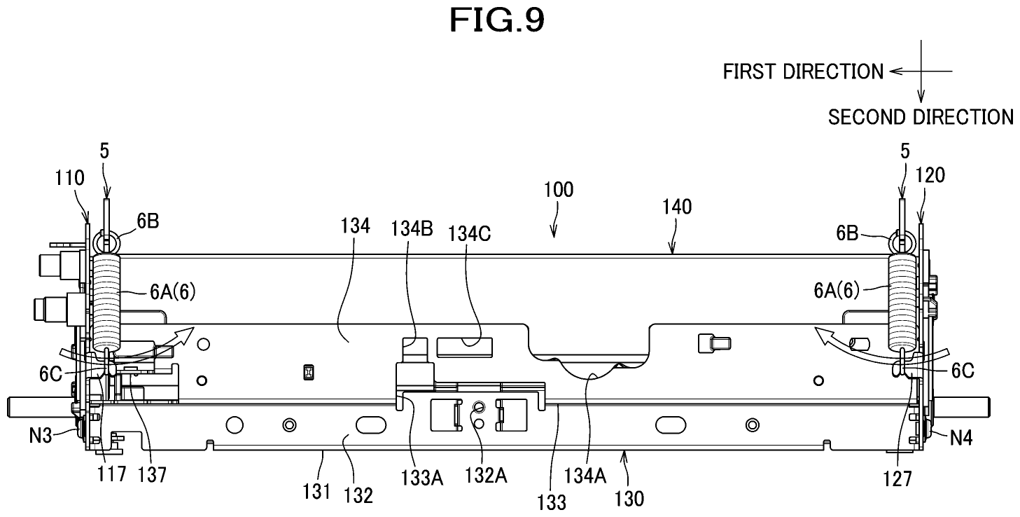

In a fixing device known in the art, a spring that biases the arm is disposed on an end portion of the side frame, and a distance between the spring and the heating roller is larger than a distance between the cam and the heating roller. As a result, a portion of the side frame with which an end of the spring is engaged and the area around it are prone to deformation. For example, the side frame is easily deformed in the direction indicated by the arrows in FIG. 9 and this sometimes caused the entire fixing frame to deform.

However, in the fixing device 1 according to the present embodiment, the spring 6 biasing the arm 5 is located between the third axis 3X, which is the rotation axis of the cam 7, and the first connecting frame 130, and the first connecting frame 130 is located between the spring 6 and the heating roller 2 as viewed in the first direction. Therefore, compared to an alternative fixing device known in the art, the distance between the spring 6 and the heating roller 2 is smaller than the distance between the cam 7 and the heating roller 2, and the first spring engaging portion 117 of the first side frame 110 with which the spring 6 is engaged is reinforced by the first connecting frame 130. As a result, the first side frame 110 and the second side frame 120 can be restrained from being deformed by the biasing force of the spring 6.

The spring 6 is located on the inner side of the fixing device 1 with respect to the first side frame 110 in the first direction. Thus, the first side frame 110 and the second side frame 120 can be restrained from deforming outwardly.

The first bearing portion 113 supporting the cam 7 in a manner that allows the cam 7 to rotate has a shape of a hollow cylinder extending in the first direction. Thus, a sliding area in which the cam rotates can be secured. As a result, the cam 7 can rotate smoothly and can be restrained from being detached.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The first side frame and the second side frame may comprise a portion reinforcing the strength of the base portion.

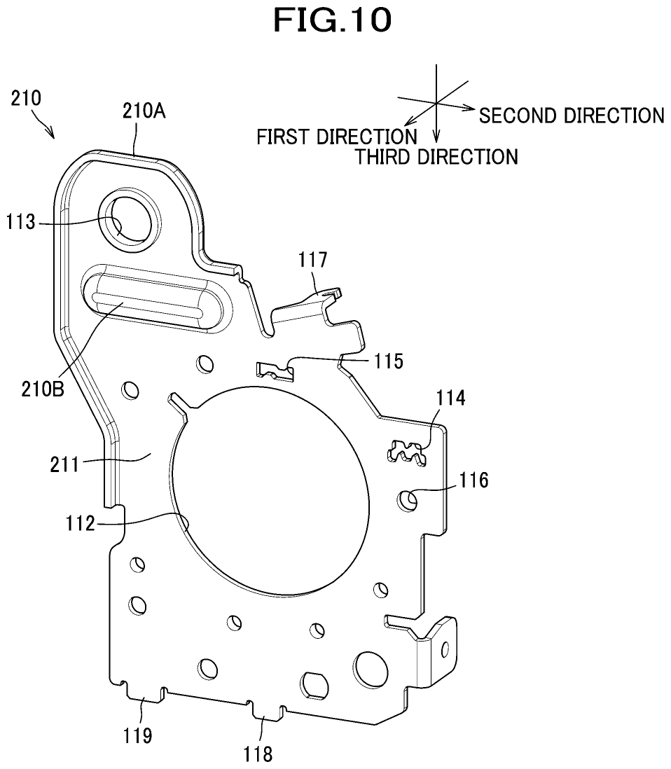

For example, the first side frame 210 shown in FIG. 10 includes a first reinforcing portion 210A and a second reinforcing portion 210B. The first reinforcing portion 210A protrudes from an edge of an outer periphery of a first base portion 211 in the first direction. The first side frame and the second side frame have a symmetrical shape, and therefore only the shape of the first side frame will be described in detail and the description of the second side frame will be omitted.

The first reinforcing portion 210A is provided at an edge of an outer periphery of the first base portion 211 surrounding the first bearing portion 113. The first reinforcing portion 210A includes a portion surrounding the portion of the first base portion 211 encircling the first bearing portion 113. The first reinforcing portion 210A surrounds the portion of the first base portion 211 encircling the first bearing portion 113 from three directions; from the one side and the other side in the second direction and from the other side in the third direction. The first reinforcing portion 210A further comprises a portion extending from the portion surrounding the first bearing portion 113 from the three directions to a position which overlaps the position of the first support hole 112 in the third direction. In this way, the first reinforcing portion 210A has a portion disposed on a side of the first support hole 112 on the other side in the third direction.

The second reinforcing portion 210B is located between the first support hole 112 and the first bearing portion 113. The second reinforcing portion 210B protrudes in the first direction and is formed in a bead-shape long in the second direction. The second reinforcing portion 210B is located on the side of the first support hole 112 on the other side in the third direction.

In this way, the first side frame 210 shown in FIG. 10 includes a first reinforcing portion 210A and a second reinforcing portion 210B which reinforce the strength of the first base portion 211; thus, the portions around the first bearing portion 113 of the cam shaft 8 to which the cam 7 is fixed can be restrained from deforming.

The first side frame 210 may comprises either the first reinforcing portion 210A or the second reinforcing portion 210B.

In FIG. 10, the first reinforcing portion 210A and the second reinforcing portion 210B protrude outward from the first side frame 210 is; however, the first reinforcing portion 210A and the second reinforcing portion 210B may protrude inward from the first side frame 210.

In the above-described embodiment, the angle between the first wall portion 131 and the second wall portion 132, the angle between the second wall portion 132 and the third wall portion 133, and the angle between the third wall portion 133 and the fourth wall portion 134 are 90 degrees; however, the angles between the wall portions are not limited to 90 degrees and may be any angle. The first wall portion 131 and the third wall portion 133 may extend from the second wall portion 132 toward the same side.

In the above-described embodiment, the fixing device 1 is installable into and removable from the main housing M of the image forming apparatus P; however, the fixing device 1 may be fixed to the main housing M such that the fixing device 1 cannot be installed into and removed from the main housing M.

In the above-described embodiment, the heating roller 2 is adopted as the heating member; however, the heating member may, for example, be a fixing belt slidably supported by a guide.

In the above-described embodiment, the first side frame 110 and the second side frame 120 support the heating roller 2 in a manner that allows the heating roller 2 to rotate; however, the first side frame 110 and the second side frame 120 may support the pressure member 3 in a manner that allows the pressure member 3 to rotate.

In the above-described embodiment, a halogen heater is given as an example of the heater H. However, the heater H may be a resistive heating element or an IH (induction heating) heat source and the like. Here, the IH heat source is a heat source that does not heat up itself, but heats the roller or the metal belt by magnetic induction heating. Although the fixing device 1 comprises two heaters H1, H2 in the above-described embodiment, the fixing device 1 may include one or more than two heaters H.

The elements described in the above embodiment and its modified examples may be implemented selectively and in combination.

1-12. (canceled)

13. A fixing device comprising:
a heating roller rotatable about a first axis extending in a rotation axis direction;
a first side frame configured to support one end portion of the heating roller in the rotation axis direction, the heating roller rotatable in a state where the first side frame supports the one end portion of the heating roller;
a second side frame configured to support another end portion of the heating roller in the rotation axis direction, the heating roller rotatable in a state where the second side frame supports the another end portion of the heating roller;
a first connecting frame made of metal and configured to connect the first side frame and the second side frame; and
a first temperature sensor configured to detect a temperature of the heating roller, the first temperature sensor including a fixed portion that is fixed to the first connecting frame and a detecting portion facing a surface of the heating roller, the detecting portion and the surface of the heating roller separated by an air gap,
wherein the first connecting frame comprises:
a first wall portion extending in the rotation axis direction,
a second wall portion extending from a side of the first wall portion, the second wall portion extending at an angle with respect to the first wall portion, and
a third wall portion extending from a side of the second wall portion opposite to the first wall portion, the third wall portion extending at an angle with respect to the second wall portion.

14. The fixing device according to claim 13, wherein the first temperature sensor is fixed to the second wall portion.

15. The fixing device according to claim 14, wherein
the third wall portion extends from the second wall portion in a direction away from the heating roller,
the first temperature sensor is fixed to a first surface of the second wall portion opposite to a side on which the heating roller is located, and
the third wall portion has a first opening through which the first temperature sensor passes.

16. The fixing device according to claim 15, wherein a dimension of the first wall portion in the rotation axis direction is greater than a dimension of the first opening of the third wall portion in the rotation axis direction.

17. The fixing device according to claim 14, wherein the first temperature sensor is fixed to the second wall portion by a screw, with a spring located between the fixed portion and the second wall portion.

18. The fixing device according to claim 14, wherein
the second wall portion includes a first insertion portion on a longitudinal end thereof on one side in the rotation axis direction, the first insertion portion protruding toward the one side in the rotation axis direction, and
the first side frame has a first hole configured to receive the first insertion portion to locate the first insertion portion in place.

19. The fixing device according to claim 14, wherein the first connecting frame includes a first fastening wall portion configured to extend in a direction perpendicular to the rotation axis direction from a longitudinal end of the second wall portion on one side in the rotation axis direction, the first fastening wall portion fastened to the first side frame by a screw.

20. The fixing device according to claim 14, wherein the first connecting frame further comprises a fourth wall portion extending from a side of the third wall portion opposite to the side on which the second wall portion is located, the fourth wall portion extending at an angle with respect to the third wall portion.

21. The fixing device according to claim 20, further comprising a thermostat spaced apart from the heating roller, the thermostat configured to shut-off power to the heating roller when a surface temperature of the heating roller exceeds a predetermined temperature,
wherein the fourth wall portion has a second opening configured to expose a temperature detecting surface of the thermostat toward the heating roller.

22. The fixing device according to claim 20, further comprising a second temperature sensor configured to contact a surface of the heating roller and detect a temperature of the heating roller,
wherein the first connecting frame further comprises an extending wall portion extending from the fourth wall portion at an angle with respect to the fourth wall portion, the second temperature sensor being fixed to the extending wall portion.

23. The fixing device according to claim 20, wherein
the fourth wall portion includes a second insertion portion on a longitudinal end thereof on one side in the rotation axis direction, the second insertion portion protruding toward the one side in the rotation axis direction, and
the first side frame has a second hole configured to receive the second insertion portion to locate the second insertion portion in place.

24. The fixing device according to claim 14, further comprising a second connecting frame made of metal and configured to connect the first side frame and the second side frame, and
wherein the rotation axis of the heating roller is located between the first connecting frame and the second connecting frame as viewed in the rotation axis direction.

25. The fixing device according to claim 24, further comprising:
a shaft located in a position different from a position of the first connecting frame and a position of the second connecting frame, the shaft configured to connect the first side frame and the second side frame;
a pressure member configured to nip a sheet in combination with the heating roller; and
an arm rotatably supported by the shaft, the arm configured to push the pressure member toward heating roller,
wherein the shaft is located in a position offset from the second connecting frame in a circumferential direction of the heating roller.

26. The fixing device according to claim 13, further comprising:
a pressure member configured to nip a sheet in combination with the heating roller;
an arm rotatable about a second axis extending in the rotation axis direction, the arm configured to push the pressure member toward the heating roller;
a spring with one end engaged with the first side frame and another end engaged with the arm, the spring biasing the arm such that the pressure member is pushed toward the heating roller; and
a cam configured to rotate about a third axis extending in the rotation axis direction, the cam configured to move the arm to change a nip pressure between the heating roller and the pressure member, and
wherein the spring is located between the third axis and the first connecting frame as viewed in the rotation axis direction, and
wherein the first connecting frame is located between the heating roller and a portion where the spring is engaged with the first side frame as viewed in the rotation axis direction.

27. The fixing device according to claim 26, wherein the spring is located on the inner side of the fixing device, in the rotation axis direction, with respect to the first side frame.

28. The fixing device according to claim 26, wherein
the first side frame and the first connecting frame are both made of metal,
the first connecting frame includes a first insertion portion on a longitudinal end thereof on one side in the rotation axis direction, the first insertion portion protruding toward the one side in the rotation axis direction, and
the first side frame has a first hole configured to receive the first insertion portion to locate the first insertion portion in place.

29. The fixing device according to claim 26, wherein
the first side frame comprises a base portion and a bearing portion that protrudes from the base portion, the bearing portion supporting the cam in a rotatable manner, and
the bearing portion has a shape of a hollow cylinder extending in the rotation axis direction.

30. The fixing device according to claim 29, wherein the base portion comprises a first reinforcing portion that protrudes in the rotation axis direction from an edge of an outer periphery of the base portion, the first reinforcing portion provided at an edge of an outer periphery of the base portion surrounding the bearing portion.

31. The fixing device according to claim 29, wherein the first side frame comprises,
a first support hole configured to support one end portion of the heating roller in a rotatable manner, and
a second reinforcing portion located between the first support hole and the bearing portion, the second reinforcing portion protruding in the rotation axis direction.
